(19) United States
(12) Patent Application Publication
(10) Pub. No.: US 2025/0000025 A1
(43) Pub. Date: Jan. 2, 2025

(54) ROTARY ACTUATOR SYSTEM FOR WORK VEHICLE

(71) Applicant: CNH Industrial America LLC, New Holland, PA (US)

(72) Inventors: Cory Douglas Hunt, Millersville, PA (US); Jeremy Kuelker, New Holland, PA (US); Stephen Todderud, Lancaster, PA (US); David Chong, New Holland, PA (US); Luis Lara, New Holland, PA (US); Shane Fanning, New Holland, PA (US); Joseph Russell Woelfling, Landisville, PA (US)

(21) Appl. No.: 18/345,340

(22) Filed: Jun. 30, 2023

(51) Int. Cl. A01D 41/14

(52) U.S. Cl. CPC A01D 41/145

(57) ABSTRACT

A system for a work vehicle includes an arm and an actuator system. The actuator system includes a drive component and a linkage assembly. The linkage assembly is coupled to the arm and the drive component. The drive component is configured to drive the linkage assembly to rotate the arm from a first position in which the arm extends forward of a working component of the work vehicle to a second position in which the arm is positioned rearward of the working component of the work vehicle.

### BACKGROUND

The present disclosure relates generally to a rotary actuator system for a work vehicle, such as a harvester.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plants. A harvesting process may begin by operating a header of the harvester to remove portions of plants from a field. In some cases, the header may cut the plants to form cut crops and transport the cut crops to a processing system of the harvester.

Certain headers include a cutter bar assembly configured to cut stalks of the plants, thereby separating the cut crops from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system. Certain headers may also include a reel, which may include a reel member having multiple fingers extending from a central framework. The fingers are configured to engage the plants, thereby preparing the plants to be cut by the cutter bar assembly and/or urging the cut crops to move toward the belt(s).

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, a system for a work vehicle includes an arm and an actuator system. The actuator system includes a drive component and a linkage assembly. The linkage assembly is coupled to the arm and the drive component. The drive component is configured to drive the linkage assembly to rotate the arm from a first position in which the arm extends forward of a working component of the work vehicle to a second position in which the arm is positioned rearward of the working component of the work vehicle.

In certain embodiments, a header for a work vehicle includes a frame, an arm rotatably coupled to the frame, a sensor supported on the arm, and an actuator system coupled to the frame and the arm, wherein the actuator system is configured to drive the arm to rotate from a first position in which the arm extends to position the sensor forward of the frame to a second position in which the arm is withdrawn to align the sensor with the frame.

In certain embodiments, a work vehicle includes a frame, an arm rotatably coupled to the frame, a sensor supported on the arm, and an actuator system coupled to the frame and the arm. The actuator system includes a drive component and a cylinder with a helical slot. The cylinder is non-rotatably coupled to the arm, and the drive component is configured to drive one or more pins to slide within the helical slot cause the arm to rotate from a first position in which the arm extends to position the sensor forward of the frame to a second position in which the arm is withdrawn to align the sensor with the frame.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system, in accordance with an aspect of the present disclosure;

FIG. 2 is a perspective view of an embodiment of a header that may be employed within the agricultural system of FIG. 1, in accordance with an aspect of the present disclosure;

FIG. 3 is a cross-sectional side view of an embodiment of the header that may be employed within the agricultural system of FIG. 1, in accordance with an aspect of the present disclosure;

FIG. 4 is a perspective rear view of an embodiment of an actuator assembly that may be employed to adjust a structure of the agricultural system of FIG. 1, wherein the actuator assembly includes a handle and is in a first configuration;

FIG. 5 is a perspective rear view of the actuator assembly of FIG. 4, wherein the actuator assembly is in a second configuration;

FIG. 6 is a perspective rear view of an embodiment of an actuator assembly that may be employed to adjust a structure of the agricultural system of FIG. 1, wherein the actuator assembly includes an electric actuator and is in a first configuration;

FIG. 7 is a perspective rear view of the actuator assembly of FIG. 6, wherein the actuator assembly is in a second configuration;

FIG. 8 is a perspective view of an embodiment of an actuator assembly that may be employed to adjust a structure of the agricultural system of FIG. 1, wherein the actuator assembly includes a helical barrel cam and a handle, and the actuator is in a first configuration;

FIG. 9 is a perspective rear view of the actuator assembly of FIG. 8, wherein the actuator assembly is in a second configuration;

FIG. 10 is perspective rear view of an embodiment of an actuator assembly that may be employed to adjust a structure of the agricultural system of FIG. 1, wherein the actuator assembly includes a motor that drives a lead screw, and the actuator assembly is in a first configuration; and

FIG. 11 is a perspective rear view of the actuator assembly of FIG. 10, wherein the actuator assembly is in a second configuration.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming typically begins with placing seeds within a field. Over time, the seeds grow into plants. Often, only a portion of each plant is commercially valuable, so each plant is harvested to separate usable crop material from a remainder of the plant. For example, a harvester may cut plants within the field via a header, which may include a flexible draper header. In particular, the header may include a cutter bar assembly configured to cut the plants to form cut crops. A conveyor coupled to draper deck(s) of the header moves the cut crops toward a crop processing system of the harvester. The crop processing system may include a threshing machine configured to thresh the cut crops, thereby separating the cut crops into certain desired agricultural materials, such as grain, and material other than grain (MOG). The desired agricultural materials may be sifted and then accumulated into a tank. When the tank fills to capacity, the desired agricultural materials may be collected from the tank. The MOG may be discarded from the harvester (e.g., via a spreader) by passing through an exit pipe or a spreader to fall down onto the field.

In some embodiments, portions of the cutter bar assembly may move so as to follow a contour of the field. For example, the cutter bar assembly may be flexible to remain in contact with the field during harvesting operations. Furthermore, the header of the harvester includes a reel (e.g., reel assembly) configured to prepare the plants to be cut by the cutter bar assembly. As an example, the reel may be positioned adjacent to the cutter bar assembly and may be configured to guide the plants toward the cutter bar assembly.

It is presently recognized that it may be desirable to position a device forward of a frame of the header relative to a forward direction of travel of the harvester. The device may be configured to facilitate detection of terrain features (e.g., a height/position of the plants and/or surface features of the field) and/or harvester features as the harvester travels through the field. For example, the device may be a sensor that is configured to detect the terrain features and to send a signal indicative of the terrain features to an electronic controller. In such cases, the electronic controller may process the signals to determine the terrain features and then may provide control signals to adjust components of the harvester (e.g., the header, the cutter bar assembly, and/or the reel assembly) based on the terrain features. As another example, the device may be a light source (e.g., visible light source) that is configured to illuminate the terrain features to enable detection and visualization by an operator of the harvester.

Further, it is presently recognized that it may be desirable to couple the device to a structure (e.g., support structure) that is configured to move (e.g., rotate) relative to the frame of the header. For example, the structure may be configured to move between a first position relative to the frame of the header to position the device forward of the frame of the header and a second position relative to the frame of the header to position the device adjacent to the frame of the header.

To drive movement of the structure and the device coupled thereto, an actuator assembly may be coupled to the structure and the frame of the header. The actuator assembly may be actuated (e.g., controlled) to drive movement of the structure to the first position relative to the frame of the header to position the device forward of the frame of the header during harvesting operations. Further, the actuator assembly may be actuated to drive movement of the structure to the second position relative to the frame of the header to position the device adjacent to the frame of the header during transport operations and/or storage. In this way, the actuator assembly and the structure may enable and provide different positions of the device according to a current operational status and/or a command input by the operator.

With the foregoing in mind, the actuator assembly described herein is configured to efficiently and effectively drive movement of the structure. Advantageously, the actuator assembly also includes features that provide a mechanical lock with the structure in the first position and in the second position, which blocks movement of the structure in the first position and in the second position to provide stability, reduce wear, and so forth. Additionally, the actuator assembly also includes features that provide a compact form that permits mounting to the frame of the header (e.g., a rear-facing surface of the frame of the header; a rear portion of the frame of header; accessible by an operator positioned/standing rearward of the frame of the header; and/or protruding rearwardly from the frame of the header) without blocking a view from a cab of the harvester, as well as features that provide access to the operator (e.g., to manipulate a handle of the actuator assembly).

It should be appreciated that the actuator assembly may be utilized to adjust any of a variety of structures of any of a variety of work vehicles, including any of a variety of construction vehicles, utility vehicles, agricultural vehicles, and so forth. For example, the actuator assembly may be utilized to adjust any of a variety of structures, such as arms, brackets, panels, tools, attachments, and so forth, of any of a variety of work vehicles, such as trucks, skid steers, tractors, planters, sprayers, harvesters, balers, and so forth.

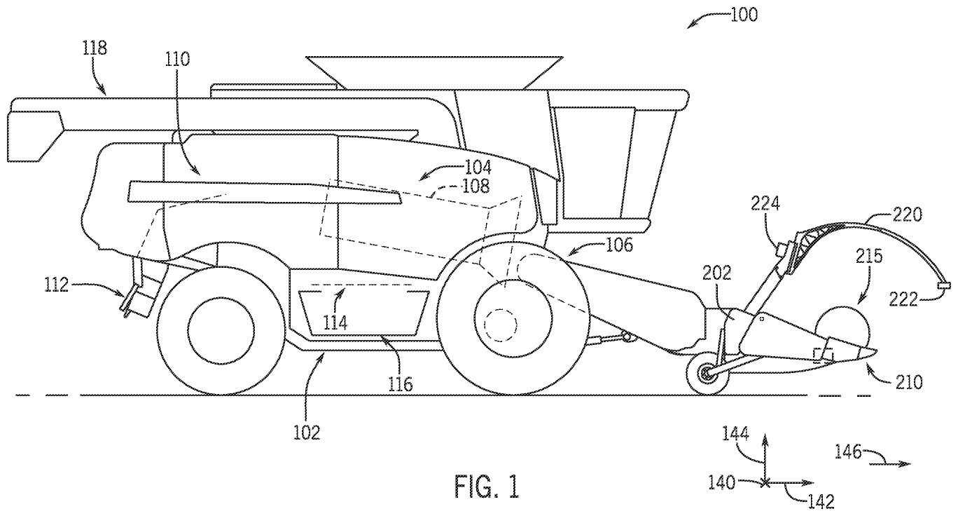

FIG. 1 is a side view of an embodiment of an agricultural system 100, which may be a harvester. The agricultural system 100 includes a chassis 102 configured to support a header 200 (e.g., working component; attachment) and an agricultural crop processing system 104. The header 200 is configured to cut plants to form cut crops and to transport the cut crops toward an inlet 106 of the agricultural crop processing system 104 for further processing of the cut crops.

The agricultural crop processing system 104 receives the cut crops from the header 200 and separates desired crop material from crop residue. For example, the agricultural crop processing system 104 may include a thresher 108 having a cylindrical threshing rotor that transports the cut crops in a helical flow path through the agricultural system 100. The thresher 108 may also separate the desired crop material (e.g., grain) from the crop residue (e.g., husks and pods), and the thresher 108 may enable the desired crop material to flow into a cleaning system 114 located beneath the thresher 108.

The cleaning system 114 may remove debris from the desired crop material and transport the desired crop material to a storage tank 116 within the agricultural system 100. When the storage tank 116 is full, a tractor with a trailer on the back may pull alongside the agricultural system 100. The desired crop material collected in the storage tank 116 may be carried up by an elevator and dumped out of an unloader 118 into the trailer. The crop residue may be transported from the thresher 108 to a crop residue handling system 110, which may process (e.g., chop/shred) and remove the crop residue from the agricultural system 100 via a crop residue spreading system 112 positioned at an aft end of the agricultural system 100. To facilitate discussion, the agricultural system 100 and/or its components may be described with reference to a lateral axis or direction 140, a longitudinal axis or direction 142, and a vertical axis or direction 144. The agricultural system 100 and/or its components may also be described with reference to a direction of travel 146 (e.g., forward direction of travel).

As discussed in detail below, the header 200 includes a cutter bar assembly 210 (e.g., tool; working component) configured to cut the plants to form the cut crops. The header 200 also includes a reel 215 (e.g., reel assembly) configured to engage the plants to prepare the plants to be cut by the cutter bar assembly 210 and/or to urge the cut crops onto a conveyor system that directs the cut crops toward the inlet 106 of the agricultural crop processing system 104. The reel 215 includes a reel member having multiple fingers (e.g., tines) extending from a central framework. The central framework is driven to rotate such that the fingers engage and move the plants and the cut crops. The cutter bar assembly 210 and the reel 215 are supported by a frame 202 of the header 200.

Additionally, the header 200 includes one or more arms 220 (e.g., structures; device arms; sensor arms). Each of the one or more arms 220 is coupled to the frame 202 of the header 200 (e.g., at a first end portion) and supports a device 222 (e.g., at a second end portion). The device 222 may be a sensor, a light, or any other device that may be used to facilitate harvesting operations and/or other operations. In certain embodiments, the device 222 may be configured to facilitate detection of terrain features (e.g., a height/position of the plants and/or surface features of the field) and/or system features (e.g., a header height, which is a distance between the header 200 and the field along the vertical axis 144) of the header 200 as the agricultural system 100 travels through the field.

For example, the device 222 may be a sensor (e.g., non-contact sensor) that is configured to detect the terrain features (e.g., obstacles) and to send a signal indicative of the terrain features to an electronic controller. In such cases, the electronic controller may process the signals to determine the terrain features and then may provide control signals to adjust components of the agricultural system 100 (e.g., the header 200, the cutter bar assembly 210, and/or the reel 215) based on the terrain features. As another example, the device 222 may be a sensor that is configured to monitor the system features of the header 200 and to send a signal indicative of the system features to an electronic controller. In such cases, the electronic controller may process the signals to determine the system features and then may provide control signals to adjust components of the agricultural system 100 (e.g., the header 200, the cutter bar assembly 210, and/or the reel 215) based on the system features. As another example, the device 222 may be a light source (e.g., visible light source) that is configured to illuminate the terrain features to enable detection and visualization by an operator of the harvester.

As described herein, one or more actuator assemblies 224 (e.g., actuator systems) may be provided to drive rotation of each of the one or more arms 220 relative to the frame 202 of the header 200. For example, each of the one or more actuator assemblies 224 may be provided to drive rotation of a respective one of the one or more arms 220 (e.g., about a rotational axis, which may substantially align with the vertical axis 144). In this way, each of the one or more actuator assemblies 224 may adjust the respective one of the one or more arms 220 from a first position to a second position relative to the frame 202 of the header 200. In certain embodiments, the device 222 may be located forward of the frame 202 of the header 200 (e.g., with respect to the forward direction of travel 146; extending along the longitudinal axis 142) with the respective one of the one or more arms 220 in the first position and may be substantially aligned with the frame 202 of the header 200 (e.g., with respect to the forward direction of travel 146 and/or the longitudinal axis 142; extending along the lateral axis 140) with the respective one of the one or more arms 220 in the second position.

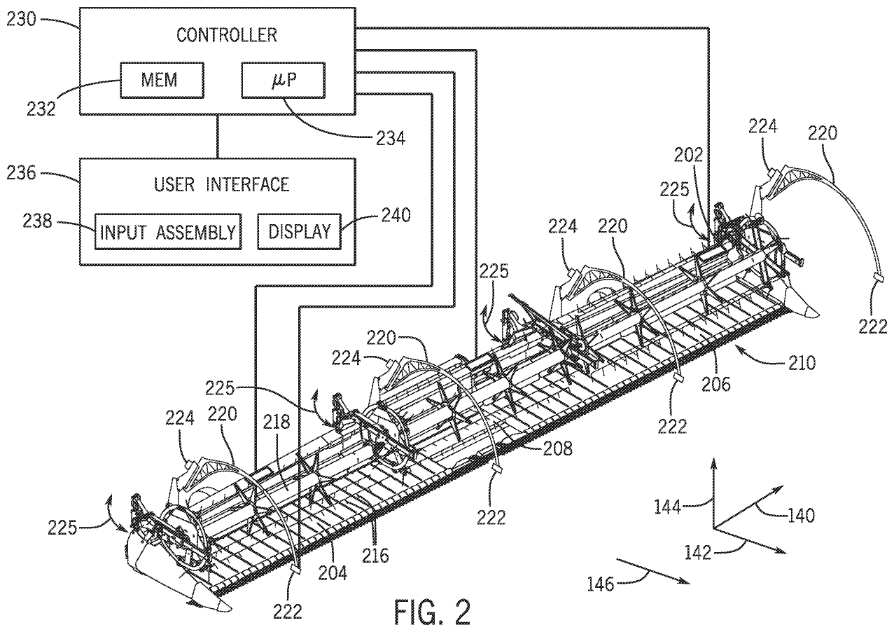

FIG. 2 is a perspective view of an embodiment of the header 200 that may be employed within the agricultural system 100 of FIG. 1. In the illustrated embodiment, the header 200 includes the cutter bar assembly 210 configured to cut the plants, thereby forming the cut crops. The cutter bar assembly 210 is positioned at a forward end of the header 200 relative to the longitudinal axis 142 of the header 200. The cutter bar assembly 210 extends along a substantial portion of the width of the header 200 (e.g., along the lateral axis 140). The cutter bar assembly 210 includes a knife (e.g., knife assembly) with a blade support, a stationary guard assembly, and a moving blade assembly. The moving blade assembly is fixed to the blade support (e.g., above the blade support along the vertical axis 144 of the header 200), and the blade support/moving blade assembly is driven to oscillate relative to the stationary guard assembly to cut the plants to form the cut crops.

As shown, the header 200 includes a first conveyor section 204 on a first lateral side of the header 200 and a second conveyor section 206 on a second lateral side of the header 200 opposite the first lateral side. The conveyor sections 204, 206 may be separate from one another. For instance, the first conveyor section 204 may extend along a portion of a width of the header 200 and the second conveyor section 206 may extend along another portion of the width of the header 200. Each conveyor section 204, 206 is driven to rotate by a suitable drive mechanism, such as an electric motor or a hydraulic motor. The first conveyor section 204 and the second conveyor section 206 are driven such that a top surface of each conveyor section 204, 206 moves laterally inward to a center conveyor section 208 positioned between the first conveyor section 204 and the second conveyor section 206 along the lateral axis 140. The center conveyor section 208 may also be driven to rotate by a suitable drive mechanism, such as an electric motor or a hydraulic motor. The center conveyor section 208 is driven such that the top surface of the center conveyor section 208 moves rearwardly relative to the direction of travel 146 toward the inlet. As a result, the conveyor sections 204, 206, 208 transport the cut crops through the inlet to the agricultural crop processing system for further processing of the cut crops. Although the illustrated header 200 includes two conveyor sections 204, 206 configured to direct crops toward the center conveyor section 208, there may be any suitable number of conveyor sections.

The reel 215 directs the plants toward the cutter bar assembly 210 and/or directs the cut crops toward the conveyor sections 204, 206, thereby substantially reducing the possibility of the cut crops falling onto the surface of the field. The reel 215 includes multiple fingers or tines 216 extending from a central framework 218. The central framework 218 is driven to rotate such that the tines 216 move (e.g., in a circular pattern).

The frame 202 of the header 200 may be movably coupled to the chassis of the agricultural system. Additionally, the cutter bar assembly 210 may be flexible along the width of the header 200 to allow the cutter bar assembly 210 to follow the contours of the field. Such features may enable a cutting height (e.g., a height at which each plant is cut) to be substantially constant across the width of the header 200. As described herein, the one or more devices 222 may be used in part to identify the terrain features and/or system features, including the contours of the field, the height of each plant, the header height, and so forth.

As shown, each of the one or more devices 222 may be attached to a respective one of the one or more arms 220. Additionally, each of the one or more actuator assemblies 224 may be provided to drive rotation of a respective one of the one or more arms 220 (e.g., about the rotational axis, as shown by arrows 225). In this way, each of the one or more actuator assemblies 224 may adjust the respective one of the one or more arms 220 from the first position to the second position relative to the frame 202 of the header 200. In certain embodiments, the device 222 may be located forward of the frame 202 of the header 200 (e.g., with respect to the forward direction of travel 146; extending along the longitudinal axis 142) with the respective one of the one or more arms 220 in the first position and may be substantially aligned with the frame 202 of the header 200 (e.g., with respect to the forward direction of travel 146 and/or the longitudinal axis 142; extending along the lateral axis 140) with the respective one of the one or more arms 220 in the second position.

The header 200 may include or be associated with a controller 230 (e.g., electronic controller) that includes a memory device 232 and a processor 234. The controller 230 may be configured to receive signals (e.g., data, information) from the one or more devices 222 and/or other components of the agricultural system. The controller 230 may be configured to process the signals to determine the terrain features and/or the system features. The controller 230 may be configured to provide control signals (e.g., instructions) to control (e.g., instruct) components of the agricultural system (e.g., the header 200, the cutter bar assembly 210, and/or the reel 215) based on the system features.

In certain embodiments, the controller 230 may be configured to provide control signals to the one or more actuator assemblies 224 to cause the one or more actuator assemblies 224 to adjust the one or more arms 220 that support the one or more devices 222. For example, a user interface 236 may include an input assembly 238 (e.g., switch, dial) and a display screen 240. It should be appreciated that in some cases the display screen 240 may display virtual buttons that operate as the input assembly 238 (e.g., via operator contact/selection of the virtual buttons on the display screen 240). In any case, the operator may provide an input that indicates a request or command to adjust the one or more arms 220 (e.g., the input that indicates a request to adjust the one or more arms 220 to the first position or to the second position; the input to initiate harvesting operations or other working operations that indicates a request to adjust the one or more arms 220 to the first position that is forward of the frame 202 of the header 200, and the input to initiate transport or storage operations that indicates a request to adjust the one or more arms to the second position to align with the frame 202 of the header 200).

The processor 234 may be used to execute software, such as software for processing signals, generating control signals, and/or other aspects. Moreover, the processor 234 may include multiple microprocessors, one or more “general-purpose” microprocessors, one or more special-purpose microprocessors, and/or one or more application specific integrated circuits (ASICS), or some combination thereof. For example, the processor 234 may include one or more reduced instruction set (RISC) or complex instruction set (CISC) processors. The memory device 232 may include a volatile memory, such as random access memory (RAM), and/or a nonvolatile memory, such as read-only memory (ROM). The memory device 232 may store a variety of information and may be used for various purposes. For example, the memory device 232 may store processor-executable instructions (e.g., firmware or software) for the processor 234 to execute, such as instructions for processing signals, generating control signals, and/or other aspects. The memory device 232 and/or the processor 234, or an additional memory and/or processor, may be located in any suitable portion of the agricultural system. By way of example, the controller 230 may be located in a cab of the agricultural system and/or on the header 200. It should be appreciated that the controller 230 may include or be part of a computing system (e.g., distributed computing system) with multiple processors and/or multiple memory devices located in any suitable portion of the agricultural system and/or remote from the agricultural system (e.g., cloud; remote work station). In such cases, the operations described herein may be distributed in any suitable manner between the multiple processors and/or the multiple memory devices (e.g., one processor performs certain operations, and another processor performs other operations).

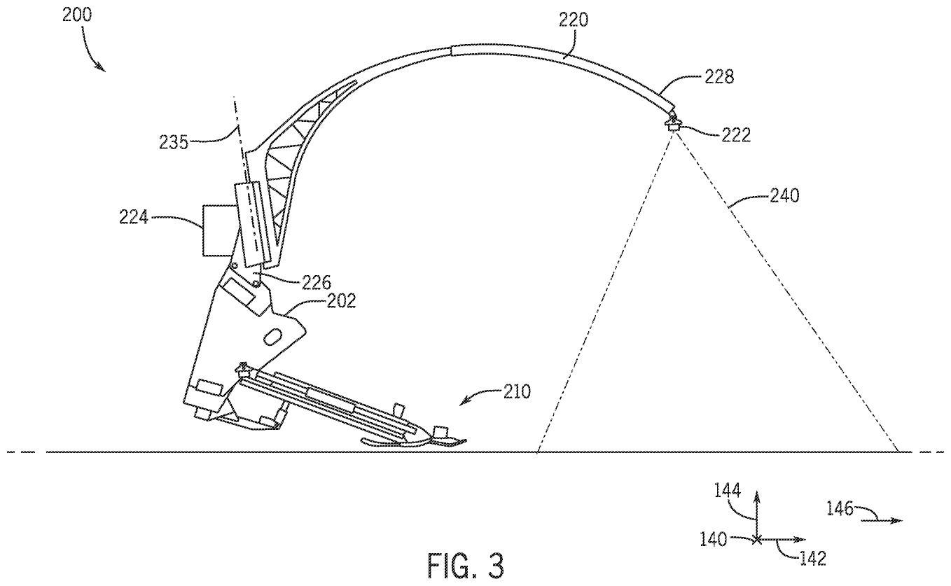

FIG. 3 is a cross-sectional side view of an embodiment of the header 200 with the reel 215 omitted for image clarity. As shown, one of the one or more arms 220 (in discussion of FIG. 3, also referred to herein as “the arm 220”) includes a first arm end 226 and a second arm end 228. The first arm end 226 is coupled (e.g., rotatably coupled) to the frame 202 of the header 200, and the second arm end 228 is coupled to a respective one of the one or more devices 222 (in discussion of FIG. 3, also referred to herein as “the device 222”).

In FIG. 3, the arm 220 is in the first position in which the arm 220 extends forward of the frame 202 of the header 200 relative to the longitudinal axis 142. In certain embodiments, with the arm 220 in the first position, the second arm end 228 is positioned forward of the frame 202 and/or forward of the cutter bar assembly 210 relative to the longitudinal axis 142. Accordingly, the device 222 is positioned forward of the frame 202 and/or forward of the cutter bar assembly 210 relative to the longitudinal axis 142. Thus, the first position may enable the device 222 to have a field of view 242 (e.g., sensor field of view or range for light distribution) that is forward (e.g., at least partially or entirely forward) of the frame 202 and/or forward of the cutter bar assembly 210 relative to the longitudinal axis 142.

As shown, a respective one of the one or more actuator assemblies 224 (in discussion of FIG. 3, also referred to herein as “the actuator assembly 224”) may be coupled to the arm 220. The actuator assembly 224 may drive rotation of the arm 220 (e.g., about the rotational axis 235). It should be appreciated that the rotation of the arm 220 may vary depending on structural features (e.g., orientation of parts); however, generally the rotation of the arm 220 may cause the second arm end 228 to move in an arc about the first arm end 226 (e.g., through approximately 45 to 100 degrees, 60 to 100 degrees, 85 to 95 degrees, or 90 degrees). Further, in certain embodiments, with the arm 220 in the first position, the second arm end 228 may substantially align with the first arm end 226 along the longitudinal axis 142. With the arm 220 in the second position, the second arm end 228 may substantially align with the first arm end 226 along the lateral axis 140. The rotation of the arm 220 may be in either direction, such as to a left side or a right side (e.g., from the first position along the longitudinal axis 142). The arm 220 may also be held (e.g., maintained; stopped) at any point or location (e.g., along the arc about the first arm end 226).

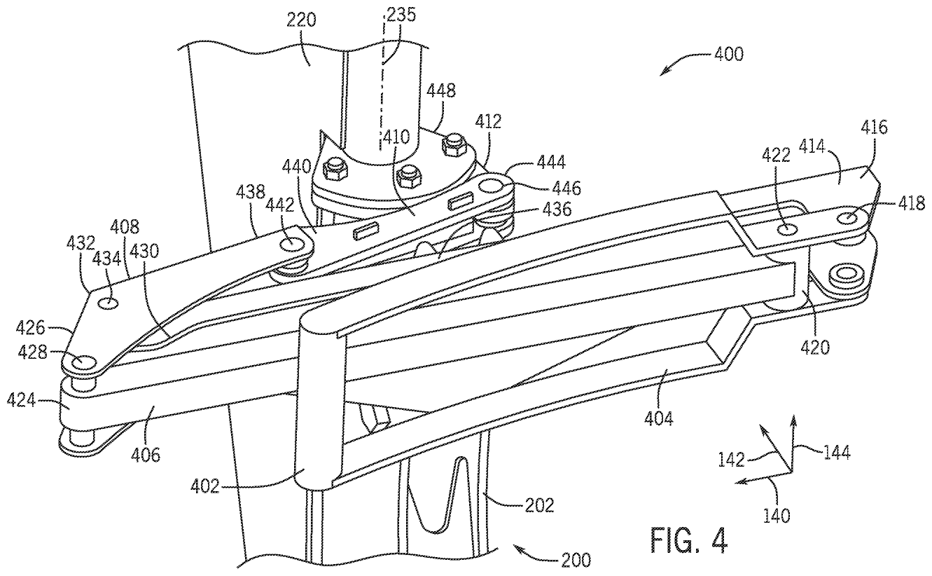

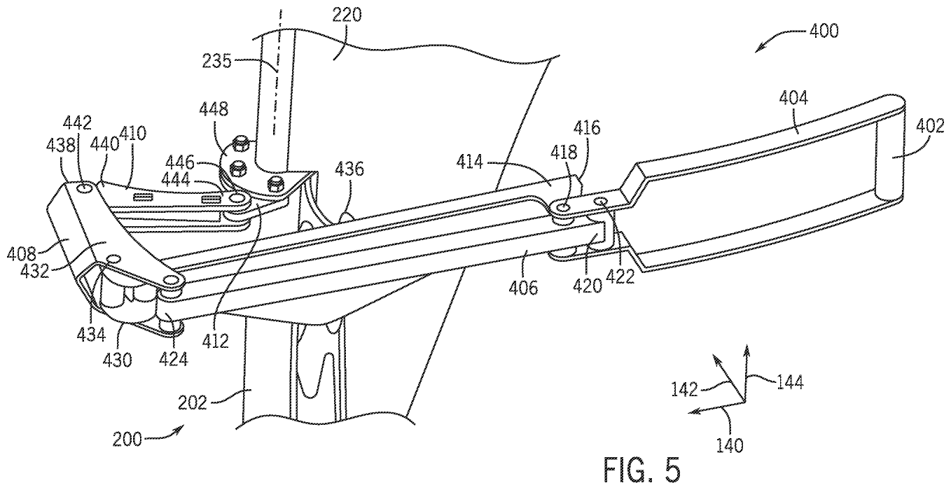

FIG. 4 is a perspective rear views of an embodiment of an actuator assembly 400 in a first configuration, which may cause the arm 220 to be in the first position. Additionally, FIG. 5 is a perspective rear view of an embodiment of the actuator assembly 400 in a second configuration, which may cause the arm 220 to be in the second position. As described herein, actuation of the actuator assembly 400 may cause rotation of the arm 220 relative to the frame 202 of the header 200 (e.g., about the rotational axis 235). It should be appreciated that the actuator assembly 400 may be utilized as the actuator assembly 224 in FIGS. 1-3.

As shown, the actuator assembly 400 is coupled to the arm 220 and to the frame 202 of the header 200. The actuator assembly 400 includes a handle 402, a lever 404, a lever arm 406, a first linkage 408, a second linkage 410, a bracket linkage 412, and a support arm 414. Certain components of the actuator assembly 400 may be considered to form a drive component, and other component of the actuator assembly 400 may be considered to form a linkage assembly. For example, the handle 402 and/or the lever 404 may be considered to form the drive component, and the lever arm 406, the first linkage 408, the second linkage 410, the bracket linkage 412, and/or the support arm 414 may be considered to form the linkage assembly. The handle 402 is part of the lever 404 and is configured to be gripped and manipulated (e.g., push/pull) by the operator to enable manual actuation of the actuator assembly 400 (e.g., to adjust the actuator assembly 400 between the first configuration of FIG. 4 and the second configuration of FIG. 5).

The lever 404 is coupled (e.g., rotatably coupled) to a first end portion 416 of the support arm 414 via a rotatable joint 418 (e.g., pin) and is also coupled (e.g., rotatably coupled) to a first end portion 420 of the lever arm 406 via a rotatable joint 422 (e.g., pin). A second end portion 424 of the lever arm 406 is coupled (e.g., rotatably coupled) to a first end portion 426 of the first linkage 408 via a rotatable joint 428 (e.g., pin), and a second end portion 430 of the support arm 414 is coupled (e.g., rotatably coupled) to an intermediate portion 432 of the first linkage 408 via a rotatable joint 434 (e.g., pin). Further, an intermediate portion 436 of the support arm 414 is coupled (e.g., fixed) to the frame 202 of the header 200.

Additionally, a second end portion 438 of the first linkage 408 is coupled (e.g., rotatably coupled) to a first end portion 440 of the second linkage 410 via a rotatable joint 442 (e.g., pin). A second end portion 444 of the second linkage 410 is coupled (e.g., rotatably coupled) to the bracket linkage 412 via a rotatable joint 446 (e.g., pin), and the bracket linkage 412 is coupled (e.g., fixed) to the arm 220 (e.g., a flange 448 of the arm 220; via one or more fasteners, such as bolts). With the actuator assembly 400 in the first configuration shown in FIG. 4, the first linkage 408 and the second linkage 410 (e.g., via connection at the rotatable joint 442) may serve as an over center lock (e.g., mechanical lock) to block rotation of the arm 220 due to outside forces (e.g., due to wind, debris, and/or terrain features).

To transfer the actuator assembly 400 from the first configuration to the second configuration (e.g., to rotate the arm 220 relative to the frame 202 of the header 200, such as from the first position to the second position), the operator may apply force to the handle 402 of the lever 404 (e.g., push/pull, such as in a laterally-extending plane) to rotate the lever 404 about the rotatable joint 418 at the support arm 414 (e.g., in the first configuration the lever 404 may be stacked behind the support arm 414, the lever arm 406, and/or other components of the actuator assembly 400 relative to the longitudinal axis 142, while in the second configuration the lever 404 may extend from the second end portion 424 of the lever arm 406). This movement of the lever 404 drives rotation/movement of other components of the actuator assembly 400, as well as the rotation of the arm 220.

With reference to FIGS. 4 and 5, the rotatable joint 418 between the lever 404 and the support arm 414 is fixed relative to the frame 202 of the header 200. Further, the rotatable joint 434 between the first linkage 408 and the support arm 414 is fixed relative to the frame 202 of the header 200. Accordingly, as the operator applies the force to the handle 402 of the lever 404 to rotate the lever 404 about the rotatable joint 418 at the support arm 414, the movement of the lever 404 drives (e.g., pulls) the lever arm 406 toward the first end portion 416 of the support arm 414 and relative to the frame 202 of the header 200. In turn, the lever arm 406 drives (e.g., pulls) the first end portion 426 of the first linkage 408 toward the first end portion 416 of the support arm 414 and relative to the frame 202 of the header 200. In turn, the first linkage 408 pivots about support arm 414 via the rotatable joint 434, which drives the first end portion 440 of the second linkage 410 and the bracket linkage 412 coupled thereto (e.g., in a direction opposite movement of the handle 402). The bracket linkage 412 is coupled (e.g., fixed) to the arm 220, such that movement of the bracket linkage 412 causes movement of the arm 220. With the actuator assembly 400 in the second configuration shown in FIG. 5, the lever 404 and the lever arm 406 (e.g., via connection at the rotatable joint 422) may serve as an over center lock (e.g., mechanical lock) to block rotation of the arm 220 due to outside forces (e.g., due to wind, debris, and/or terrain features).

In FIGS. 4 and 5, while the actuator assembly 400 is in the first configuration, the arm 220 is in the first position in which the arm 220 is generally aligned with the longitudinal axis 142 (e.g., and transverse or generally orthogonal to the lever 404, the lever arm 406, and/or the support arm 414). Further, while the actuator assembly 400 is in the second configuration, the arm 220 is in the second position in which the arm 220 is generally aligned with the lateral axis 140 (e.g., and generally parallel to the lever 404, the lever arm 406, and/or the support arm 414). However, it should be appreciated that components may be arranged such that the arm 220 rotates between the first position in which the arm 220 is generally aligned with the lateral axis 140, and the second position in which the arm 220 is generally aligned with the longitudinal axis 142. Further, the actuator assembly 400 is generally shown and described as being in a lateral plane (e.g., with the lever 404, the lever arm 406, the support arm 414, and the linkages 408, 410, 412 in the lateral plane; the support arm 414 extending along the lateral axis 140); however, it should be appreciated that the actuator assembly 400 may be positioned and/or oriented in any suitable manner to drive desirable rotation of the arm 220 or other rotatable component that is coupled to the actuator assembly 400.

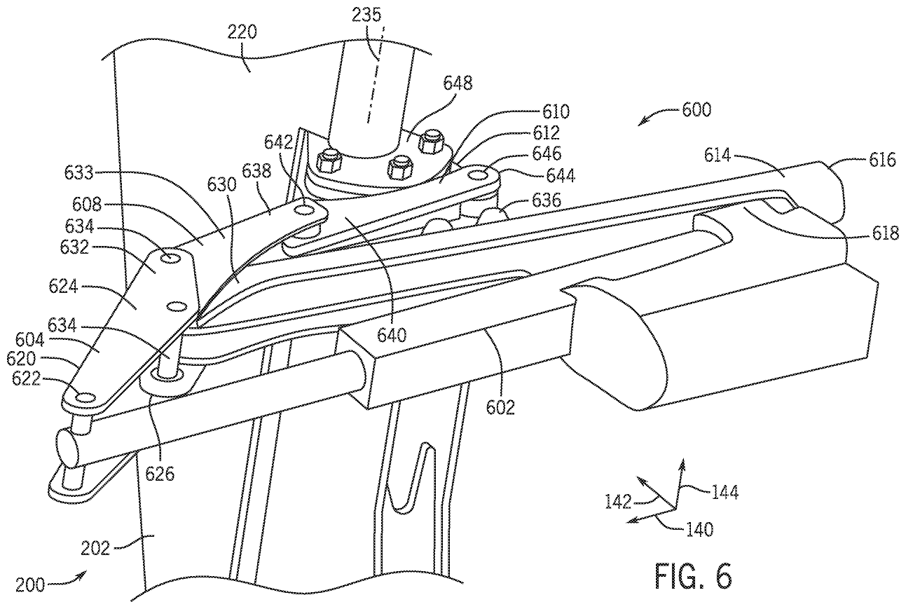

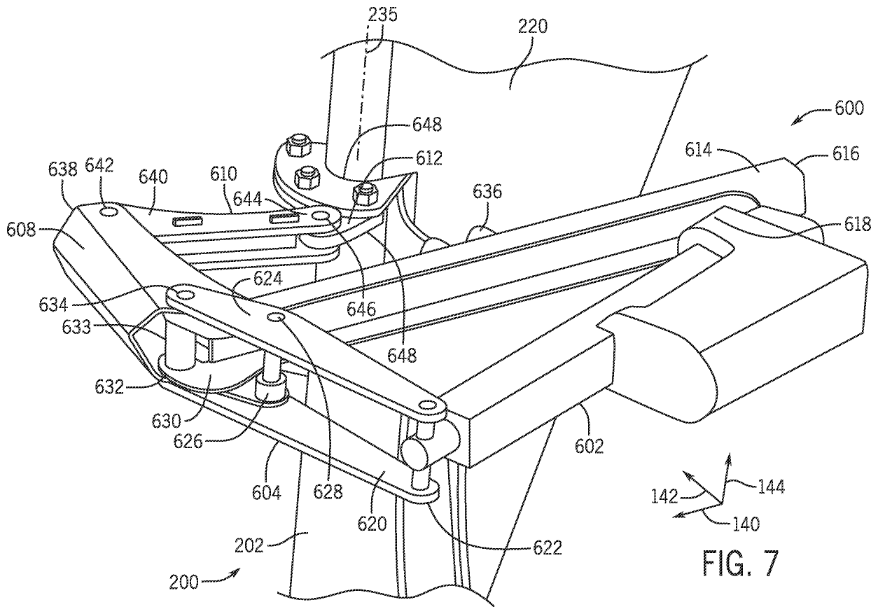

FIG. 6 is a perspective rear views of an embodiment of an actuator assembly 600 in a first configuration, which may cause the arm 220 to be in the first position. Additionally, FIG. 7 is a perspective rear view of an embodiment of the actuator assembly 600 in a second configuration, which may cause the arm 220 to be in the second position. As described herein, actuation of the actuator assembly 600 may cause rotation of the arm 220 relative to the frame 202 of the header 200 (e.g., about the rotational axis 235). It should be appreciated that the actuator assembly 600 may be utilized as the actuator assembly 224 in FIGS. 1-3.

As shown, the actuator assembly 600 is coupled to the arm 220 and to the frame 202 of the header 200. The actuator assembly 600 includes an actuator 602 (e.g., linear actuator; lever), an actuator linkage 604 (e.g., lever arm), a first linkage 608, a second linkage 610, a bracket linkage 612, and a support arm 614. Certain components of the actuator assembly 600 may be considered to form a drive component, and other component of the actuator assembly 600 may be considered to form a linkage assembly. For example, the actuator 602 may be considered to form the drive component, and the actuator linkage 604, the first linkage 608, the second linkage 610, the bracket linkage 612, and/or the support arm 614 may be considered to form the linkage assembly. The actuator 602 may be actuated (e.g., electrically, hydraulically, pneumatically; via control signals from the controller 230 of FIG. 2) to adjust the actuator assembly 600 between the first configuration of FIG. 6 and the second configuration of FIG. 7.

The actuator 602 is coupled (e.g., rotatably coupled) to a first end portion 616 of the support arm 614 via a rotatable joint 618 (e.g., pin) and is also coupled (e.g., rotatably coupled) to a first end portion 620 of the actuator linkage 604 via a rotatable joint 622 (e.g., pin). An intermediate portion 624 of the actuator linkage 604 is coupled (e.g., rotatably coupled) to a first end portion 626 of the first linkage 608 via a rotatable joint 628 (e.g., pin), and a second end portion 630 of the support arm 614 is coupled (e.g., rotatably coupled) to a second end portion 632 of the actuator linkage 604 and an intermediate portion 633 of the first linkage 608 via a rotatable joint 634 (e.g., pin). Further, an intermediate portion 636 of the support arm 614 is coupled (e.g., fixed) to the frame 202 of the header 200.

Additionally, a second end portion 638 of the first linkage 608 is coupled (e.g., rotatably coupled) to a first end portion 640 of the second linkage 610 via a rotatable joint 642 (e.g., pin). A second end portion 644 of the second linkage 610 is coupled (e.g., rotatably coupled) to the bracket linkage 612 via a rotatable joint 646 (e.g., pin), and the bracket linkage 612 is coupled (e.g., fixed) to the arm 220 (e.g., a flange 648 of the arm 220; via one or more fasteners, such as bolts). With the actuator assembly 600 in the first configuration shown in FIG. 6, the first linkage 608 and the second linkage 610 (e.g., via connection at the rotatable joint 642) may serve as an over center lock (e.g., mechanical lock) to block rotation of the arm 220 due to outside forces (e.g., due to wind, debris, and/or terrain features).

To transfer the actuator assembly 600 from the first configuration to the second configuration (e.g., to rotate the arm 220 relative to the frame 202 of the header 200, such as from the first position to the second position), the actuator 602 may retract (e.g., an actuator rod) to rotate the actuator linkage 604 about the rotatable joint 634 at the support arm 614. This actuation of the actuator 602 and movement of the actuator linkage 604 causes rotation/movement of other components of the actuator assembly 600, as well as the rotation of the arm 220.

With reference to FIGS. 6 and 7, the rotatable joint 618 between the actuator 602 and the support arm 614 is fixed relative to the frame 202 of the header 200. Further, the rotatable joint 634 between the actuator linkage 604, the first linkage 608, and the support arm 614 is fixed relative to the frame 202 of the header 200. Accordingly, as the actuator 602 applies force to the actuator linkage 604 to rotate the actuator linkage 604 about the rotatable joint 634 at the support arm 614, the movement of the actuator linkage 604 drives the first linkage 608, which drives the second linkage 610 and the bracket linkage 612 coupled thereto (e.g., in a direction opposite movement of the actuator 602). The bracket linkage 612 is coupled (e.g., fixed) to the arm 220, such that movement of the bracket linkage 612 causes movement of the arm 220. The actuator linkage 604 and the first linkage 608 are fixed to one another and may be considered one component (e.g., a first linkage or an extended first linkage) and/or may be constructed as one piece, and may operate to provide increased mechanical advantage for the actuator 602 (e.g., as compared to without the actuator linkage 604 or such extended portion of the first linkage 608), as well as to allow less force transfer from the arm 220 to the actuator 602 (e.g., through the first linkage 608 and the actuator linkage 604).

In FIGS. 6 and 7, while the actuator assembly 600 is in the first configuration, the arm 220 is in the first position in which the arm 220 is generally aligned with the longitudinal axis 142 (e.g., and transverse or generally orthogonal to the actuator 602 and/or the support arm 614). Further, while the actuator assembly 600 is in the second configuration, the arm 220 is in the second position in which the arm 220 is generally aligned with the lateral axis 140 (e.g., and generally parallel to the actuator 602 and/or the support arm 614). However, it should be appreciated that components may be arranged such that the arm 220 rotates between the first position in which the arm 220 is generally aligned with the lateral axis 140, and the second position in which the arm 220 is generally aligned with the longitudinal axis 142. Further, the actuator assembly 600 is generally shown and described as being in a lateral plane (e.g., with the actuator 602, the support arm 614, and the linkages 604, 608, 610, 612 in the lateral plane; the support arm 614 extending along the lateral axis 140); however, it should be appreciated that the actuator assembly 600 may be positioned and/or oriented in any suitable manner to drive desirable rotation of the arm 220 or other rotatable component that is coupled to the actuator assembly 600.

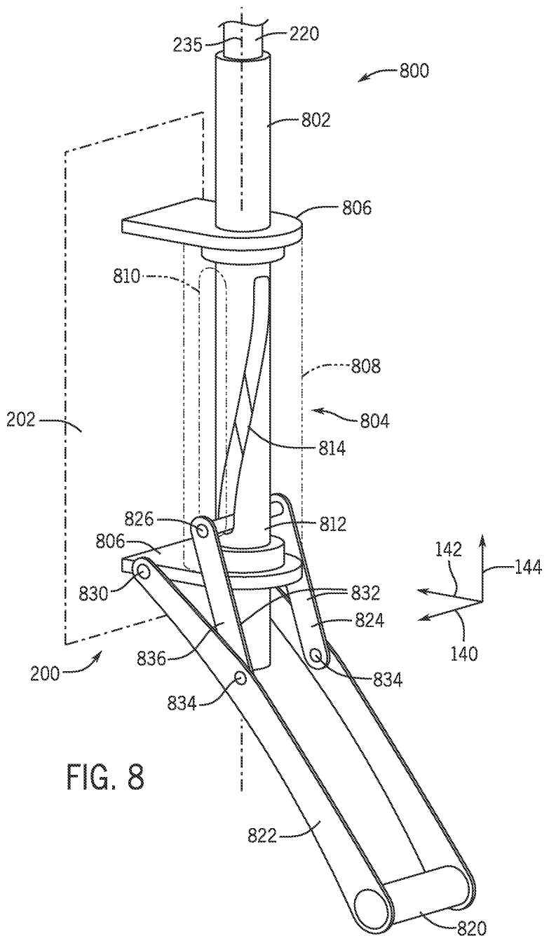

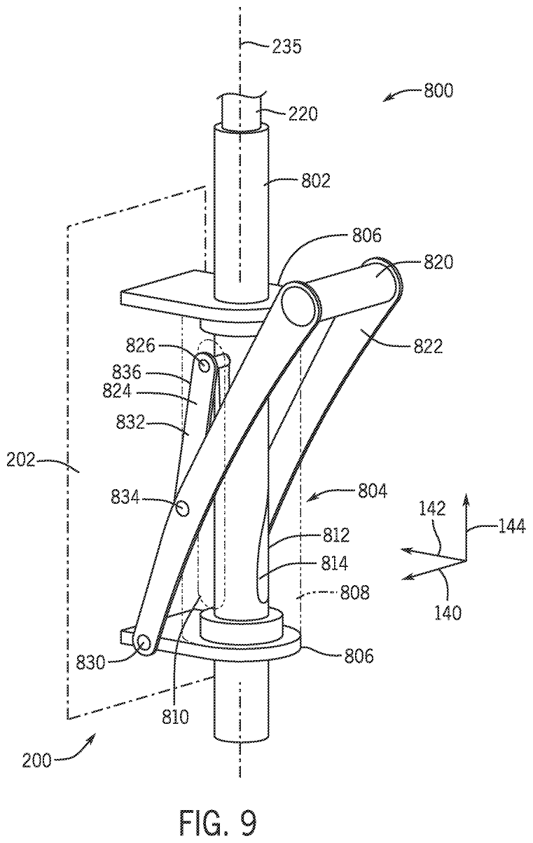

FIG. 8 is a perspective rear view of an embodiment of an actuator assembly 800 in a first configuration, which may cause the arm 220 to be in the first position. Additionally, FIG. 9 is a perspective rear view of an embodiment of the actuator assembly 800 in a second configuration, which may cause the arm 220 to be in the second position. As described herein, actuation of the actuator assembly 800 may cause rotation of the arm 220 relative to the frame 202 of the header 200 (e.g., about the rotational axis 235). It should be appreciated that the actuator assembly 800 may be utilized as the actuator assembly 224 in FIGS. 1-3.

As shown, the actuator assembly 800 is coupled to the arm 220 and to the frame 202 of the header 200. More particularly, the actuator assembly 800 includes a shaft 802 that is coupled (e.g., fixed; rotate together) to the arm 220, as well as a housing 804 that is coupled (e.g., fixed) to the frame 202 of the header 200. The housing 804 may include support brackets 806 that contact and mount to the frame 202 of the header 200 (e.g., via one or more fasteners, such as bolts). The housing 804 may also include an outer structure 808 (e.g., outer barrel or cylinder) that includes one or more slots 810 (e.g., diametrically opposed; on opposite sides of the outer structure 808). The one or more slots 810 may be formed through a side wall of the outer structure 808 or may be otherwise defined by the outer structure 808, and the one or more slots 810 may be straight or linear slots that extend along a respective axis (e.g., in a straight line; an entirety of each of the one or more slots 810 is parallel to the rotational axis 235).

The shaft 802 (and the arm 220 coupled thereto) may be coupled (e.g., fixed; rotate together) to an inner structure 812 (e.g., inner barrel or cylinder) that includes one or more helical slots 814. The one or more helical slots 814 may be formed through a side wall of the inner structure 812 or may be otherwise defined by the inner structure 812, and the one or more helical slots 814 may have a helical form to wrap circumferentially about the inner structure 812.

The actuator assembly 800 also includes a handle 820, a lever 822, pin arms 824, and one or more pins 826. Certain components of the actuator assembly 800 may be considered to form a drive component, and other component of the actuator assembly 800 may be considered to form a linkage assembly. For example, the handle 820 and/or the lever 822 may be considered to form the drive component, and the pin arms 824, the outer structure 808 with the one or more slots 810, the inner structure 812 with the one or more helical slots 814, the shaft 802, and/or the support brackets 806 may be considered to form the linkage assembly. The handle 820 is part of the lever 822 and is configured to be gripped and manipulated (e.g., push/pull) by the operator to enable manual actuation of the actuator assembly 800 (e.g., to adjust the actuator assembly 800 between the first configuration of FIG. 8 and the second configuration of FIG. 9). The lever 822 is coupled (e.g., rotatably coupled) to a the housing 804 (e.g., to one of the support brackets 806, such as a lowermost support bracket 806) via a rotatable joint 830 (e.g., pin) and is also coupled (e.g., rotatably coupled) to respective first end portions 832 of the pin arms 824 via rotatable joints 834 (e.g., pins). Respective second end portions 836 of the pin arms 824 support (e.g., are coupled to) the one or more pins 826, which are positioned within (e.g., extend through) the one or more slots 810 and the one or more helical slots 814.

To transfer the actuator assembly 800 from the first configuration to the second configuration (e.g., to rotate the arm 220 relative to the frame 202 of the header 200, such as from the first position to the second position), the operator may apply force to the handle 820 of the lever 822 (e.g., push/pull, such as toward or away from a ground surface or in a vertically-extending plane) to rotate the lever 822 about the rotatable joint 830 at the housing 804. This movement of the lever 822 drives rotation/movement of other components of the actuator assembly 800, as well as the rotation of the arm 220.

With reference to FIGS. 8 and 9, the housing 804 (including the support brackets 806 and the outer structure 808 with the one or more slots 810) is fixed relative to the frame 202 of the header 200. The inner structure 812 is configured to rotate within the housing 804 (e.g., within the outer structure 808; via bearings) and relative to the frame 202 of the header 200. Accordingly, as the lever 822 drives the pin arms 824, the pin arms 824 force the one or more pins 826 to move (e.g., slide; follow) along the one or more slots 810 and the one or more helical slots 814, which drives rotation of the inner structure 812 within the housing 804 (and the shaft 802 and the arm 220; along the rotational axis 235).

The actuator assembly 800 may include certain features to facilitate locking (e.g., mechanical locking) in the first configuration and the second configuration. For example, the one or more helical slots 814 may include straight or linear end portions or segments to provide the locking in the first configuration and the second configuration. As another example, the one or more helical slots 814 may include tapered end portions or segments (e.g., smaller dimension circumferentially about the inner structure 812) to provide the locking in the first configuration and the second configuration. Thus, while in first configuration and the second configuration, the actuator assembly 800 may block rotation of the arm 220 due to outside forces (e.g., due to wind, debris, and/or terrain features).

In FIGS. 8 and 9, while the actuator assembly 800 is in the first configuration, the arm 220 is in the first position in which the arm 220 is generally aligned with the longitudinal axis 142 (e.g., and with an axis of the lever 822). Further, while the actuator assembly 800 is in the second configuration, the arm 220 is in the second position in which the arm 220 is generally aligned with the lateral axis 140 (e.g., and transverse or generally orthogonal to the axis of the lever 822). However, it should be appreciated that components may be arranged such that the arm 220 rotates between the first position in which the arm 220 is generally aligned with the lateral axis 140, and the second position in which the arm 220 is generally aligned with the longitudinal axis 142. Further, the actuator assembly 800 is generally shown and described as being actuated via force applied along the vertical axis 144 (e.g., toward and away from the ground surface); however, it should be appreciated that the actuator assembly 800 may be positioned and/or oriented in any suitable manner to drive desirable rotation of the arm 220 or other rotatable component that is coupled to the actuator assembly 800.

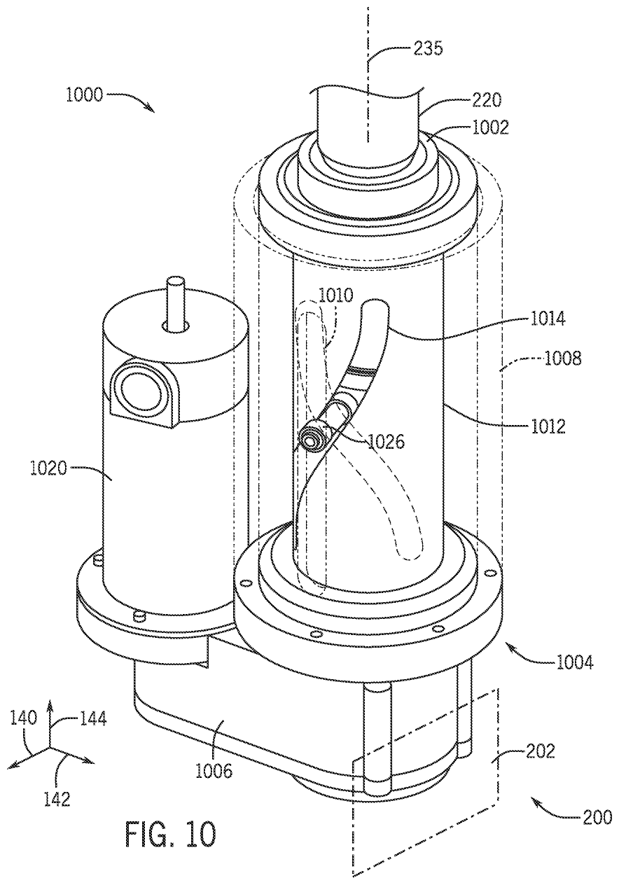

Additionally, in FIGS. 8 and 9, the actuator assembly 800 includes the one or more helical slots 814 that extend about a portion (e.g., 25 percent) of a circumference of the inner structure 812, which provide a corresponding rotation (e.g., 90 degrees) of the shaft 802 and the arm 220. However, it should be appreciated that the one or more helical slots 814 may have any configuration (e.g., dimensions; 10, 20, 30, 40, or 50 percent) to provide any corresponding rotation (e.g., degrees) of the shaft 802 and the arm 220. Further, other configuration are envisioned, such as configurations in which the one or more slots 810 are also helical slots, but with an opposite curvature to provide additional rotation of the shaft 802 and the arm 220 without affecting structural integrity of the inner structure 812 (e.g., see FIG. 10).

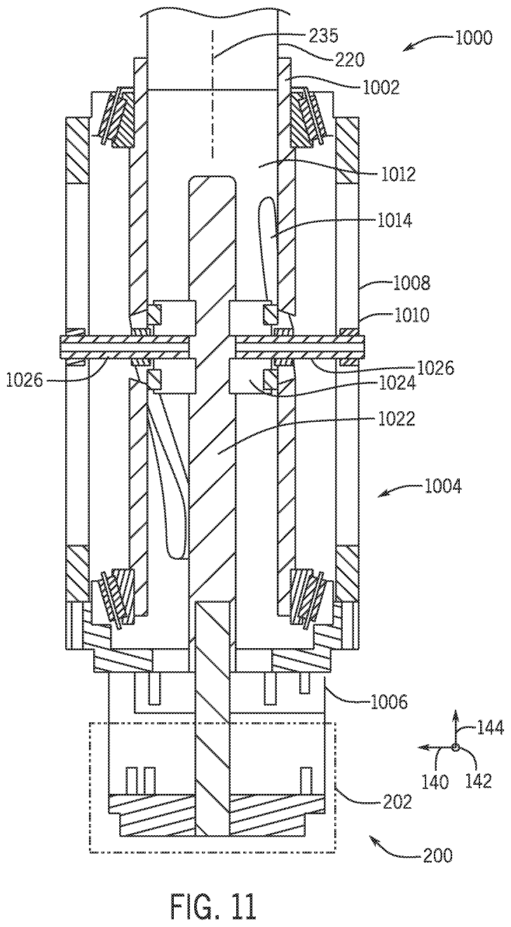

FIG. 10 is a perspective rear view of an embodiment of an actuator assembly 1000 as the actuator assembly 1000 transitions between a first configuration and a second configuration. Additionally, FIG. 11 is a cross-sectional side view of an embodiment of the actuator assembly 1000 as the actuator assembly 1000 transitions between the first configuration and the second configuration. As described herein, actuation of the actuator assembly 1000 may cause rotation of the arm 220 relative to the frame 202 of the header 200 (e.g., about the rotational axis 235). It should be appreciated that the actuator assembly 1000 may be utilized as the actuator assembly 224 in FIGS. 1-3.

As shown, the actuator assembly 1000 is coupled to the arm 220 and to the frame 202 of the header 200. More particularly, the actuator assembly 1000 includes a shaft 1002 that is coupled (e.g., fixed; rotate together) to the arm 220, as well as a housing 1004 that is coupled (e.g., fixed) to the frame 202 of the header 200. The housing 1004 may include a support bracket 1006 that contacts and mounts to the frame 202 of the header 200 (e.g., via one or more fasteners, such as bolts). The housing 1004 may also include an outer structure 1008 (e.g., outer barrel or cylinder) that includes one or more slots 1010 (e.g., diametrically opposed; on opposite sides of the outer structure 1008). The one or more slots 1010 may be formed through a side wall of the outer structure 1008 or may be otherwise defined by the outer structure 1008, and the one or more slots 1010 may be straight or linear slots that extend along a respective axis (e.g., in a straight line; an entirety of each of the one or more slots 1010 is parallel to the rotational axis 235).

The shaft 1002 (and the arm 220 coupled thereto) may be coupled (e.g., fixed; rotate together) to an inner structure 1212 (e.g., inner barrel or cylinder) that includes one or more helical slots 1014. The one or more helical slots 1014 may be formed through a side wall of the inner structure 1012 or may be otherwise defined by the inner structure 1012, and the one or more helical slots 1014 may have a helical form to wrap circumferentially about the inner structure 1012.

The actuator assembly 1000 also includes a motor 1020 (e.g., electrical motor), a lead screw 1022, a carrier nut 1024, and one or more pins 1026. The motor 1020 is positioned outside (e.g., offset) from the lead screw 1022, and the lead screw 1022 is positioned within the outer structure 1008 and the inner structure 1012. In operation, an output shaft of the motor 1020 drives rotation of the lead screw 1022, which causes the carrier nut 1024 to move (e.g., via threads) along lead screw 1022 (e.g., along the vertical axis 144). The one or more pins 1026 are coupled (e.g., fixed) to the carrier nut 1024 and are positioned within (e.g., extend through) the one or more slots 1010 and the one or more helical slots 1014. Accordingly, as the motor 1020 drives the lead screw 1022, the carrier nut 1024 carries the one or more pins 1026 to move (e.g., slide; follow) along the one or more slots 1010 and the one or more helical slots 1014, which drives rotation of the inner structure 1012 within the outer structure 1008 (and the shaft 1002 and the arm 220; along the rotational axis 235). Certain components of the actuator assembly 1000 may be considered to form a drive component, and other component of the actuator assembly 1000 may be considered to form a linkage assembly. For example, the motor 1020 may be considered to form the drive component, and the lead screw 1022, the carrier nut 1024, the one or more pins 1026, the outer structure 1008 with the one or more slots 1010, the inner structure 1012 with the one or more helical slots 1014, and/or the shaft 1002 may be considered to form the linkage assembly.

The actuator assembly 1000 may include certain features to facilitate locking (e.g., mechanical locking) in the first configuration and the second configuration. For example, the one or more helical slots 1014 may include straight or linear end portions or segments to provide the locking in the first configuration and the second configuration. As another example, the one or more helical slots 1014 may include tapered end portions or segments (e.g., smaller dimension circumferentially about the inner structure 1012) to provide the locking in the first configuration and the second configuration. Thus, while in first configuration and the second configuration, the actuator assembly 1000 may block rotation of the arm 220 due to outside forces (e.g., due to wind, debris, and/or terrain features).

While the actuator assembly 1000 is in the first configuration, the arm 220 may be in the first position in which the arm 220 is generally aligned with the longitudinal axis 142. Further, while the actuator assembly 1000 is in the second configuration, the arm 220 may be in the second position in which the arm 220 is generally aligned with the lateral axis 140. However, it should be appreciated that components may be arranged such that the arm 220 rotates between the first position in which the arm 220 is generally aligned with the lateral axis 140, and the second position in which the arm 220 is generally aligned with the longitudinal axis 142. Further, the actuator assembly 1000 is generally shown and described with the lead screw 1022 extending along the vertical axis 144; however, it should be appreciated that the actuator assembly 1000 may be positioned and/or oriented in any suitable manner to drive desirable rotation of the arm 220 or other rotatable component that is coupled to the actuator assembly 1000.

Additionally, in FIGS. 10 and 11, the actuator assembly 1000 includes the one or more helical slots 1014 that extend about a portion (e.g., 25 percent) of a circumference of the inner structure 1012, which provides a corresponding rotation (e.g., 90 degrees) of the shaft 1002 and the arm 220. However, it should be appreciated that the one or more helical slots 1014 may have any configuration (e.g., dimensions; 10, 20, 30, 40, or 50 percent) to provide any corresponding rotation (e.g., degrees) of the shaft 1002 and the arm 220. Further, other configuration are envisioned, such as configurations in which the one or more slots 1010 are also helical slots, but with an opposite curvature to provide additional rotation of the shaft 1002 and the arm 220 without affecting structural integrity of the inner structure 1012. As an example, an additional helical slot 1040 that may be used as one of the one or more slots 1010 is shown in dashed lines in FIG. 10 to facilitate discussion.

As described herein, an actuator assembly (e.g., the actuator assembly 224, 400, 600, 800, 1000) may facilitate rotation of a structure (e.g., the arm 220) of a work vehicle (e.g., the agricultural system 100). The actuator assembly may include certain features that provide a mechanical lock to block rotation of the structure in certain positions (e.g., the first position and the second positions; end positions). The mechanical lock may provide stability during harvesting operations (e.g., for monitoring with a device on the structure), as well as reduced vibrational loading forces on the actuator assembly (e.g., reduced wear; extending operational life). The mechanical lock may be beneficial even when the actuator assembly includes an actuator (e.g., the actuator 602 or the motor 1020), as the mechanical lock may be effective to block the rotation of the structure without power to the actuator. Further, the actuator assembly may be positioned and/or oriented on the work vehicle in a manner that facilitates work operations (e.g., harvesting operations). For example, the actuator assembly may extend laterally so as to maintain visibility from a cab of the work vehicle. As another example, the actuator assembly may be compact and configured to be mounted in an accessible location, such as along a rearward-facing surface of an attachment (e.g., a header) of the work vehicle and/or rearward of a work component (e.g., a cutter bar assembly and/or a reel) of the attachment. As another example, the actuator assembly may extend vertically and/or be configured to enable an operator to actuate the actuator assembly by applying force in a vertical direction (e.g., toward and away from a ground surface), which may facilitate actuation by the operator (e.g., due to improved leverage and/or access).

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any features shown or described with reference to FIGS. 1-11 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system for a work vehicle, the system comprising:
an arm; and
an actuator system comprising:
a drive component; and
a linkage assembly coupled to the arm and the drive component;
wherein the drive component is configured to drive the linkage assembly to rotate the arm from a first position in which the arm extends forward of a working component of the work vehicle to a second position in which the arm is positioned rearward of the working component of the work vehicle.

2. The system of claim 1, comprising one or more devices supported on the arm.

3. The system of claim 2, wherein the one or more devices comprise a sensor, a light emitter, or both.

4. The system of claim 2, wherein the one or more devices comprise a sensor configured to detect terrain features, system features, or both.

5. The system of claim 1, wherein the drive component comprises a lever with a handle configured to be gripped by an operator.

6. The system of claim 1, wherein the drive component comprises a linear actuator.

7. The system of claim 1, wherein the linkage assembly comprises an over center linkage.

8. The system of claim 1, wherein the linkage assembly comprises a cylinder with a helical slot.

9. The system of claim 8, wherein the linkage assembly comprises an outer structure with a linear slot and an inner structure with the helical slot.

10. The system of claim 9, wherein the drive component comprises a motor, and the linkage assembly comprises a lead screw that is driven to rotate via the motor.

11. The system of claim 10, wherein the linkage assembly comprises a carrier nut that is threaded onto the lead screw and supports one or more pins, and the one or more pins are positioned within the linear slot and the helical slot.

12. The system of claim 1, wherein the work vehicle comprises an agricultural harvester, and the working component comprises a cutter bar assembly.

13. The system of claim 1, comprising a header, wherein the drive component is configured to drive the linkage assembly to rotate the arm relative to a frame of the header.

14. The system of claim 1, wherein the drive component is configured to drive the linkage assembly to rotate the arm through an arc between approximately 45 to 100 degrees.

15. The system of claim 1, comprising a controller with one or more processors, wherein the controller is configured to:
receive an operator input indicative of a request to perform a working operation; and
in response to receipt of the operator input, instruct the actuator system to adjust the arm to the first position.

16. A header for a work vehicle, the header comprising:
a frame;
an arm rotatably coupled to the frame;
a sensor supported on the arm; and
an actuator system coupled to the frame and the arm, wherein the actuator system is configured to drive the arm to rotate from a first position in which the arm extends to position the sensor forward of the frame to a second position in which the arm is withdrawn to align the sensor with the frame.

17. The header of claim 16, the actuator system is coupled to a rearward portion of the frame relative to a direction of travel.

18. The header of claim 16, wherein the actuator system comprises a drive component and a linkage assembly, and the linkage assembly comprises an over center linkage.

19. The header of claim 16, wherein the actuator system comprises a drive component and a linkage assembly, and the linkage assembly comprises a cylinder with a helical slot.

20. A work vehicle, comprising:
a frame;
an arm rotatably coupled to the frame;
a sensor supported on the arm; and
an actuator system coupled to the frame and the arm, wherein the actuator system comprises:
a drive component; and
a cylinder with a helical slot, wherein the cylinder is non-rotatably coupled to the arm, and the drive component is configured to drive one or more pins to slide within the helical slot cause the arm to rotate from a first position in which the arm extends to position the sensor forward of the frame to a second position in which the arm is withdrawn to align the sensor with the frame.
